(19) United States
(12) Patent Application Publication
(10) Pub. No.: US 2009/0299513 A1
(43) Pub. Date: Dec. 3, 2009

(54) PRODUCT RECOVERY MANAGEMENT SYSTEM

(75) Inventors: Suk-hwan Suh, Pohang-si (KR); Ju-myung Um, Daejeon (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: POSTECH ACADEMY-INDUSTRY FOUNDATION, Pohang-si (KR)

(21) Appl. No.: 12/475,236

(22) Filed: May 29, 2009

(30) Foreign Application Priority Data
May 30, 2008 (KR) 10-2008-0050938

(51) Int. Cl. G06F 17/00; G06F 3/048; G06N 5/02; G06G 7/66

(52) U.S. Cl. 700/107; 706/54; 715/771; 703/13

(57) ABSTRACT

A product recovery management system is provided for assisting a worker who lacks professional knowledge or experiences of related products to efficiently, easily perform a product recovery work. The system includes a Device to Ubiquitous (D2U) interface module, a product recovery management system (PRMS) database (DB) that stores product information and various types of information related to product recovery, a product recognizing module that refers to one of the PRMS DB and the product lifecycle information infrastructure for information of a corresponding information using an identification (ID) of the product transmitted from the D2U interface module. The system further includes a recovery plan making module provides a user terminal of a worker with steps and related information necessary for a product recovery process through the user interface module using the product information collected from the product lifecycle information infrastructure.

### BACKGROUND

The present invention relates to a product recovery management system, and more particularly, to a product recovery management system for assisting a worker who lacks professional knowledge or experiences of related products to efficiently, easily perform a product recovery work.

Due to computer and Internet technology that has developed since the late twentieth century, manufacturing fields have been globalized and specialized and an e-Manufacturing paradigm enabling Design-Anywhere Build-Anywhere (DABA) has appeared.

E-Manufacturing has enabled global manufacturing throughout the world, by that designing, manufacturing, and selling are performed, and information is interchanged using information technology (IT). The e-Manufacturing has opened a digital manufacturing era in which information is digitalized so as to virtually simulate and analyze manufacturing processes of products from designing to manufacturing using computers.

Enterprise business environments have been changed into user- and participation-focused environments representative of Web 2.0, and the world has recognized environmental problems associated with the e-Manufacturing. Thus, policies for making manufacturers responsible for recycling and disusing steps of products, such as Waste Electrical and Electronic Equipment Directive (WEEE), Extended Producer Responsibility (EPR), End of Life Vehicles Directive (ELV), or the like, have been propelled or reinforced.

These social changes demand expansions and renovations of manufacturing fields. In other words, manufacturers are required to design and manufacture products on client demands through information shares and participation of external subjects such as clients of the manufacturers. Simultaneously, responsibilities and management fields of the manufacturers are required to be extended to whole lifecycles of products including designing, manufacturing, maintaining, disusing, and recycling of the products.

However, it is limited and difficult for participants in a whole product lifecycle to access information in order to participate in manufacturing activities using only the e-Manufacturing paradigm. Thus, it is not easy to reflect various types of designing and manufacturing data obtained in product designing and manufacturing steps and product use and fault history of a client in recycling in order to remanufacture a product. In other words, the e-Manufacturing paradigm pursues only information in the manufacturing step, and related solutions such as product data management (PDM), product lifecycle management (PLM), and the like function as information systems that support collaborations in processes of manufacturing products. Thus, improvement of the process from the designing step to the manufacturing step and information interchange management may be relatively well performed. Information is very limitedly interchanged among the participants, such as a manufacturer, a client, and a recycler, in the whole product lifecycle from a selling of a product to recycling of the product. Thus, it is impossible for the recycler to utilize a series of product history information including information of the product obtained in an initial manufacturing process (i.e., information related to a structure, manufacturing, and assembling of the product), information (i.e., maintenance-related or repair-related information) used after the product has been marketed, etc. in order to recycle the product.

FIG. 1 illustrates a conventional product recovery process. As shown in FIG. 1, most steps of the conventional product recovery process are nearly similar to those of a general manufacturing process except for a wasted part-using step. However, the wasted part-using step, i.e., inspecting and disassembling of a product, recycling of parts of the product, and replacing and reprocessing of the parts, require many works that are hard for an unskilled worker to treat. Thus, a skilled worker mainly manually treats the hard works. Information interchanges between a recycler and other participants, such as a manufacturer, a seller, a customer, and a maintainer, in a product lifecycle are broken off. Thus, product manufacturing information related to disassembling and assembling of the product and product use information, such as problems occurring in use of the product, product use patterns, and replacing of the parts, are insufficient. As a result, a worker depends on experiences and intuition in most steps of recovering the product.

In the inspecting step of the product, it is not easy for the unskilled worker to decide a state of the product if the worker is unfamiliar with such product. The worker may perform the disassembling step using only a drawing of the product that has been collected. In the recycling step of the parts, the worker may check raw and synthetic materials of the parts that are difficult to be distinguished with the naked eyes. In the reprocessing step, the worker may directly write a part program according to a decision of the worker. The worker may check only the drawing of the product in order to perform the assembling step.

As described above, the conventional product recovery process mainly depends on a manual work. Thus, a large amount of time is required to recover unit products, which limits an amount of work. Since main works, such as inspecting, disassembling, reprocessing, and the like, excessively depend on specialties of skilled workers, reliability of recovered products are lower.

In addition, there is no unit for appropriately feeding recovery-related information of products back to a manufacturer. Thus, a product designer or the like of the manufacturer is not able to efficiently use main data that is accumulated in a product recovery process when improving corresponding products.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A product recovery management system is provided to collect product information, including specifications, structures, and use history of products that have been collected to be recovered, from various types of systems of participants in a product lifecycle. The product recovery management system generates inspecting, disassembling, reprocessing, and assembling steps and related information necessary in a product recovery process from the collected product information, and forwards the inspecting, disassembling, reprocessing, and assembling steps and the related information to a terminal of a worker so as to considerably reduce time and cost required for the product recovery process and assist a low-skilled worker to easily perform the product recovery process.

According to one aspect of an embodiment, a product recovery management system is provided to assist a worker to feed the recovered work results input to a terminal of the worker back to a manufacturer through an automated path so as to assist a product designer of the manufacturer to improve a design of a product using information that is accumulated in a product recovery process.

According to another aspect, a product recovery management system includes a Device to Ubiquitous (D2U) interface module that provides an interface with the D2U system, a user interface module that provides an interface with a user terminal of a worker through the D2U system; a product recovery management system (PRMS) database (DB) that stores product information and various types of information related to the product recovery process. The system further includes a product-recognizing module that refers to one of the PRMS DB and the product lifecycle information infrastructure for information of a corresponding information using an identification (ID) of the product transmitted from the D2U interface module and a recovery plan-making module that provides a user terminal of a worker with steps and related information necessary for a product recovery process through the user interface module using the product information collected from the product lifecycle information infrastructure.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates a conventional product recovery process;

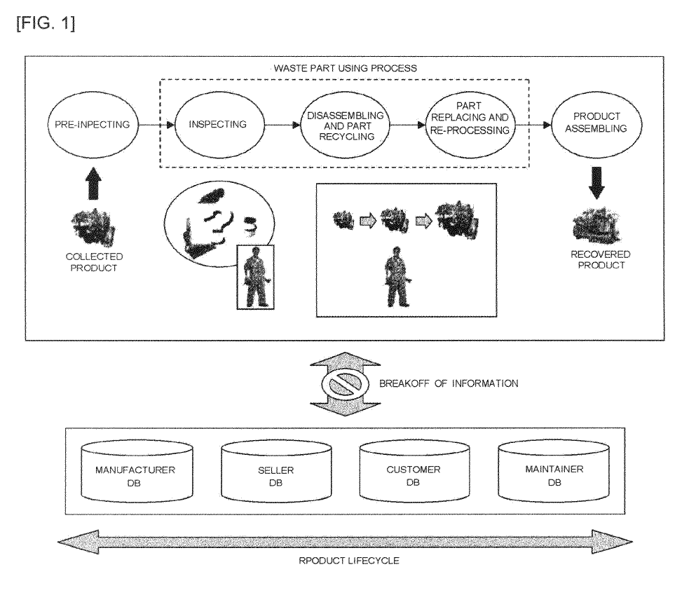

FIG. 2 is a block diagram of a product lifecycle management system according to an embodiment of the present invention; and

FIG. 3 is a flowchart of a product recovery process that is performed using a product recovery management system of FIG. 2, according to an embodiment of the present invention.

### DETAILED DESCRIPTION

The present invention will now be described more fully with reference to the accompanying drawings, in which exemplary embodiments of the present invention are shown.

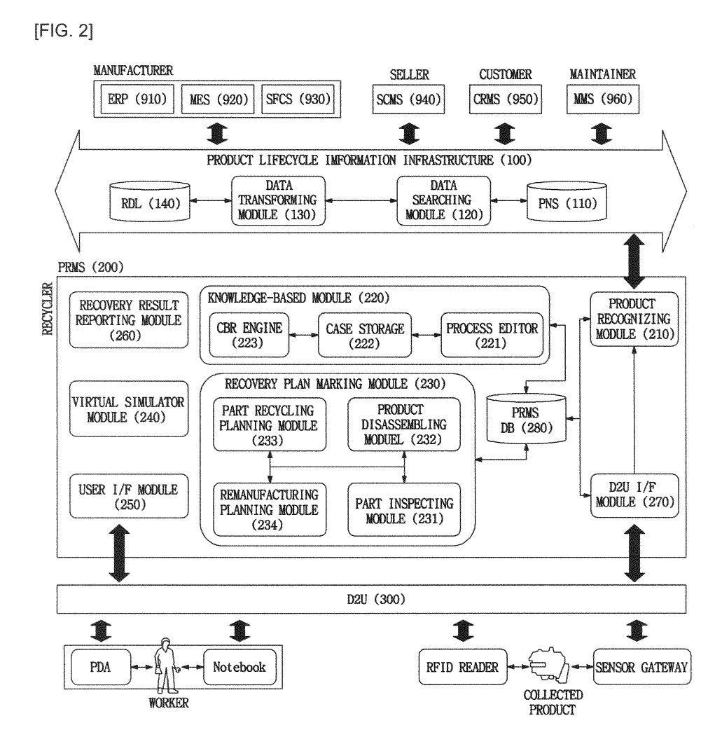

FIG. 2 is a block diagram of a product lifecycle management system according to an embodiment of the present invention. Referring to FIG. 2, the product lifecycle management system according to the present embodiment includes a product lifecycle information infrastructure 100, a product recovery management system (PRMS) 200, and a Device to Ubiquitous (D2U) system 300. The product lifecycle information infrastructure 100 integrates and manages information that is collected throughout a product life cycle. The PRMS 200 is connected to the product lifecycle information infrastructure 100 to automatically manage the product recovery process. The D2U system 300 integrates and manages products and peripheral devices in a shop floor using ubiquitous technology in order to connect the products and the peripheral devices to the PRMS 200.

The product lifecycle information infrastructure 100 obtains product-related information from participant systems throughout the product lifecycle, i.e., in Begin of Life (BOL), Middle of Life (MOL), and End of Life (EOL) steps, and transforms the product-related information into standardized information. The product lifecycle information infrastructure 100 also provides interfaces for information interchanges among the participant systems. Here, the participant systems respectively correspond to an enterprise resource planning (ERP) 910, a manufacturing execution system (MES) 920, a shop floor control system (SFCS) 930, a supply chain management system (SCMS) 940, and a customer relations management system (CRMS) 950, and a maintenance management system (MMS) 960. In the BOL step, the ERP 910, the MES 920, and the SCMS 930 are established in a manufacturer, and the SCMS 940 is established in a seller. In the MOL step, the CRMS 950 is established in a customer or the MMS 960 is established in a maintainer. The PRMS 200 of the present embodiment corresponds to a recycler system used in the EOL step and thus belongs to a participant system connected to the product lifecycle information infrastructure 100.

The product lifecycle information infrastructure 100 includes a product name server (PNS) 110, a data searching module 120, a data transforming module 130, and a reference data library (RDL) 140. The PNS 110 and the data searching module 120 search for and refer to product data, and the data transforming module 130 and the RDL 140 integrate the product data. The PNS 110, the data searching module 120, the data transforming module 130, and the RDL 140 will now be described in more detail.

The PNS 110 connects product identifications (IDs) (e.g., electronic product codes (EPCs)) respectively managed by the participant systems to one another and manages uniform resource locators (URLs) of the participant systems respectively corresponding to the product IDs. In general, an available memory space is limited in a device (e.g., a radio frequency identification (RFID) tag) installed in a product. Thus, the PRMS 200 directly accesses databases (DBs) of the participant systems in order to obtain the product-related information. For this purpose, the URLs provided from the PNS 110 are used.

The data searching module 120 accesses the DBs of the participant systems through an Internet based on the URLs provided from the PNS 110 in order to search for the product information. Since one product includes a plurality of parts, the data searching module 120 may be constituted so as to search for information of each part of each product.

The data transforming module 130 transforms the product information searched by the data searching module 120 into information that can be used by the PRMS 200. In other words, since data provided from DBs of various types of participants includes incompatible terms and information systems, data locally used in the DBs of the participants is mapped into international standard data using an ontology language such as an Extensible Markup Language (XML) or an Ontology Web Language (OWL).

The RDL 140 is a DB that stores mapping information about a relation between local ontology and international standard ontology and provides the data transforming module 130 with reference information for transforming the product information. When a URL of a DB of a participant is newly input to the PNS 110, the RDL 140 synchronizes with the PNS 110 to add mapping information about local ontology corresponding to the URL into the RDL 140 so as to update information. Here, the product information may comply with international standards prescribed in Application Protocol (AP) 239 of International Organization for Standardization (ISO) 10303.

The D2U system 300 is connected to products and various types of devices positioned in the shop floor of the recycler through various types of sensors, a sensor network, or RFID to integrate the obtained product information so as to provide the integrated product information to the PRMS 200 or forward various types of information transmitted from the PRMS 200 to the various types of devices installed in the shop floor of the recycler.

Korean Patent Application No. 2008-0050782 (entitled “Product Lifecycle Information Management System Using Ubiquitous Technology) applied by the applicant of the present invention will be referred to for details of the product lifecycle information infrastructure 100 and the D2U system 300.

The PRMS 200 of the present embodiment is a system which decides a recovery process of a product and report the decision result to a participant such as a PRMS user or a manufacturer (a designer of the manufacturer). The PRMS 200 includes a product recognizing module 210, a knowledge-based module 220, a recovery plan making module 230, a virtual simulator module 240, a user interface module 250, a recovery result reporting module 260, and a D2U interface module 270. Here, the product recognizing module 210, the knowledge-based module 220, and the recovery plan making module 230 are used to decide the recovery process of the product. The virtual simulator module 240, the user interface module 250, and the recovery result reporting module 260 are used to report results of the recovery process. The D2U interface module 270 is used to obtain data. The PRMS 200 further includes a PRMS DB 280 that stores the product information and various types of information related to the product recovery process.

The D2U interface module 270 performs an interface function of transforming various types of information transmitted through the D2U system 300 and forwarding the transformed information to another module of the PRMS 200. For example, the D2U interface module 270 forwards a product ID received from the RFID or the like to the product recognizing module 210 and stores product information received from an embedded system in the PRMS DB 280.

The user interface module 250 provides an interface between the PRMS 200 and a user terminal 700 used by a worker through the D2U system 300. The user interface module 250 also includes hardware communication devices for various types of devices such as a personal digital assistant (PDA), a smart phone, a personal computer (PC), and the like that can access the PRMS 200 by wire and wireless, and data modules that are necessary for communicating with the various types of devices.

The product recognizing module 210 refers to the PRMS DB 280 or the product lifecycle information infrastructure 100 for information of a corresponding product using a product ID transmitted from the D2U interface module 270 in order to recognize a specific product. If the PRMS DB 280 does not store the information of the corresponding product, the product recognizing module 210 requests the PNS 110 of the product lifecycle information infrastructure 100 of related information and stores the request result in the PRMS DB 280.

The knowledge-based module 220 makes a knowledge-based decision using previous product recovery results so as to make a more efficient product recovery plan. The knowledge-based module 220 includes a process editor 221, a recovery result storage 222, and a case-based reasoning (CBR) engine 223. The process editor 221 provides a user interface so as to assist a user to arbitrarily edit a product recovery process applied to an existing case and a product recovery process established by the CBR engine 223. The recovery result storage 222 stores information about the previous product recovery results. The CBR engine 223 searches the recovery result storage 222 for a case of the previous product recovery results similar to a product to be currently recovered in order to perform knowledge-based reasoning. Here, the CBR engine 223 compares similarity between cases using manufacturing information (a product model, a manufacturer, etc.), final states (a function state, an external appearance state, a state of each part, etc.) of a product, and use product (a use period, user environments, etc.) as comparison parameters. The CBR engine 223 establishes a new product recovery process with reference to a product recovery process of a similar case obtained through the similarity comparison process.

The recovery plan making module 230 generates steps and related information necessary for the product recovery process using the product information collected from the product lifecycle information infrastructure 100 so as to provide the user terminal 700 of the user (e.g., the worker of the recycler) with the steps and the generated information through the user interface module 250. In other words, the recovery plan making module 230 provides a core function of supporting a worker so as to perform a product recovery process including initial part inspecting, product disassembling, part recycling, product assembling, quality inspecting, and finishing steps.

The recovery plan making module 230 includes a part inspecting module 231 that supports the initial part inspecting step, a product disassembling module 232 that supports the product disassembling step, a part recycling planning module 233 that supports a decision of a recycling plan of parts to be disused, and a remanufacturing planning module 234 that supports the part recovery, product assembling, quality inspecting, and finishing steps. Functions of the part inspecting module 231, the product disassembling module 232, the part recycling planning module 233, and the remanufacturing planning module 234 will now be described in more detail.

The part inspecting module 231 communicates with the user terminal 700 through the user interface module 250 in order to forward an inspecting guide to a corresponding product and receive a state of each part inspected by the worker, wherein the inspecting guide is provided from the manufacturer to the worker.

The product disassembling module 232 writes a connection diagram and a preceding work relation using an assembly drawing, part shapes, and a combining method stored in the PRMS DB 280, writes a list of groups of realizable parts, and allocates cost and time required for each disassembling work in order to compute an optimal path. In general, product information includes only information about product assembling but omits information related to product disassembling. Thus, the product disassembling module 232 may be constituted so as to present an optimal product disassembling process of removing defective parts from a product that is to be recovered.

The remanufacturing planning module 234 decides whether a corresponding product is to be repaired, remanufactured, or disused or whether parts are to be extracted from the corresponding product. The remanufacturing planning module 234 also decides a quality of each of the parts based on history information and inspection results of the parts and measures appropriate prices through secondary market information so as to compare costs incurred when repairing, remanufacturing, and disusing the product and extracting parts and to report the comparison result to the worker.

The part recycling planning module 233 checks materials of the parts based on Bill of Materials (BOM) information and processing guides to the materials provided from the manufacturer in order to inspect recycling possibilities and burying methods of the materials and whether the parts have used environment restriction materials.

The knowledge-based module 220 provides an inspecting method, a disassembling method, and a remanufacturing plan of a case similar to a collected product, a quality of a remanufactured product, and records of a worker so as to support the worker to make a decision using the recovery plan established by the recovery plan making module 230 and information provided from the knowledge-based module 220.

The recovery plan making module 230 having the above-described structure re-provides the knowledge-based module 220 with the product recovery results input by the worker so as to store the product recovery results as case data that will be used by the knowledge-based module 220.

The virtual simulator module 240 shows a result of performing a graphic simulation with respect to a recovery process plan to the user terminal 700 of the worker through the user interface module 250. Here, the virtual simulator module 240 provides a function similar to a simulation function of a computer-aided design (CAD)/computer-aided manufacturing (CAM) or a virtual manufacturing system.

The recovery result reporting module 260 generates the product recovery results (states of recovered parts, problems occurring in the remanufacturing process, etc.) input through the user terminal 700 of the worker as standardized data and provides the standardized data to an external system through the product lifecycle information infrastructure 100. The recovery result reporting module 260 may support a feedback of product information from the recycler to the manufacturer. Thus, the manufacturer may further improve a product using the product recovery results provided from the recycler. In other words, the recovery result reporting data generated by the recovery result porting module 260 is fed back to an information system such an ERP or the like of the manufacturer through the product lifecycle information infrastructure 100. The product designer of the manufacturer revises a design of a product based on the feedback information so as to improve a recycling rate and a remanufacturing rate of the product.

The PRMS DB 280 stores the product information and various types of information related to product recovery. Here, the stored information may be greatly divided into product specification information, product structure information, product history information, and product state information.

The product specification information includes an ID and specification of each product so as to identify each product obtained by a sensor device such as an RFID. The product specification information also includes information used in EPCs, e.g., a product category, a product model, DB information of the manufacturer, and the like.

The product structure information is generated by a product developer of the manufacturer and includes information about an assembly structure, part versions, combination relation definitions during assembling, specifications of materials, and the like. The information may comply with international standards, i.e., standards compatible with ISO 10303-AP 203 for geometric models and BOM, ISO 14649 for micro-process plans of parts, ISO 10303-AP 224 for feature-based part structures, or the like.

The product history information includes various types of information provided from participants throughout a product lifecycle of a corresponding product, i.e., information about faults, replacements, waste parts, etc. Here, the product history information may comply with standards that are compatible with ISO 10303 AP 239 for product lifecycle support (PLCS).

The product state information is information about a state of a product collected from various types of sensors (an RFID reader installed in a shop floor of the recycler, various types of sensors installed in the product, etc.) and a worker in a shop floor and includes information about performance data, aging data, sensor data, market prices, disassembling cost, part states, etc.

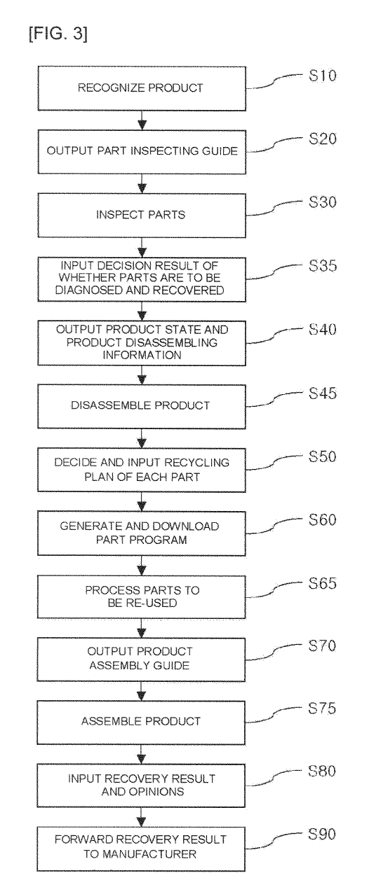

FIG. 3 is a flowchart of a product recovery process that is performed using a product recovery management system of FIG. 2, according to an embodiment of the present invention.

A case where an excavator engine is recovered according the product recovery process using the product recovery management system having the above-described structure will exemplarily be described with reference to FIG. 3.

In operation S10, a product inspector of a recycler scans a serial number of a collected engine product through the user terminal 700 of the product inspector, i.e., an RFID reader of a PDA, in order to recognize the engine product. In operation S20, the user terminal 700 communicates with the PRMS 200 of a PC installed in a shop floor in order to output part models and part inspecting guides of the engine product to the product inspector. Here, the user terminal 700 communicates with the D2U interface module 270 of the PRMS 200 through the D2U system 300. The product recognizing module 210 of the PRMS 200 refers to the PRMS DB 280 for the part inspecting guides, which are provided and stored from the manufacturer, using the serial number transmitted from the user terminal 700 or refers to the case storage 222 for inspection records of a similar product and transmits the reference result to the user terminal 700.

In operation S30, the product inspector inspects parts according to the part inspecting guide output to the user terminal 700. When the remanufacturing planning module 234 computes process cost required for repairing, remanufacturing, and disusing the engine product and a unit cost of the product based on secondary market price information and a state of the engine product and outputs the computation result to the user terminal 700, the product inspector decides whether parts are to be recovered, based on the computation result of the remanufacturing planning module 235 and inputs the decision result in operation S35. Here, although the product inspector is not a skilled engineer, the product inspector may easily decide whether the parts are to be inspected and recovered, according to the inspecting guides and the computation result of the cost that the PRMS 200 provides to a user terminal of the product inspector.

When operation S35 is completely performed, a product disassembler who has undertaken the engine product outputs states and product disassembling information of the engine product to a user terminal of the product disassemble in operation S40. In operation S45, the product disassemble disassembles the engine product based on the product disassembling information. Here, the virtual simulator 240 displays product disassembling 3-dimensional (3D) simulation including a disassembling method of each part to a user terminal using the product disassembling guides generated by the product disassembling module 232 of the PRMS 200, and the product disassembler may easily disassemble the complicated engine product to parts with reference to the product disassembling 3D simulation.

In operation S50, a part recycler who has undertaken parts to be disused from the product disassembler decides a recycling plan of the corresponding parts using a user terminal of the product recycler and inputs the decision result. Here, the user terminal receives BOM information stored in the PRMS DB 280 and outputs related regulations and processing guides related to materials of the parts in order to support a decision of the product disassembler.

If the parts to be recycled are decided in operation S50, in operation S60, the remanufacturing planning module 234 of the PRMS 200 generates a part program of parts that are to be additionally processed to be re-used and downloads the part program to a network computer (NC) or STEP-NC through the D2U system 300. In operation S65, a re-processor re-processes the parts to be re-used, using the part program downloaded from the PRMS 200 without the necessity of directly writing the part program.

In operation S70, a product assembler receives a product assembly guide from the PRMS 200 using a user terminal of the product assembler and outputs the product assembly guide. In operation S75, the product assembler assembles the engine product according to the output product assembly guide. Here, the product assembler may easily assemble the engine product with reference to the part assembling 3D simulation displayed on the user terminal.

In operation S80, the worker inputs a recovery result and opinions of the worker according to a process output to a user terminal of the worker through the PRMS 200. In operation S90, the recovery result is transmitted to the PRMS 200 through the D2U system 300 and then to a system of the manufacturer through the product lifecycle information infrastructure 100. As a result, the product designer of the manufacturer uses the recovery result to improve a design of a product so as to improve a performance of the product.

As described above, a product recovery management system according to some embodiments reduces time and cost required for a product recovery process and assists a lowly skilled worker to easily perform the product recovery process. As a result, the product recovery management system improves work efficiency of a recycler and reliability of a quality of a recovered product. Also, the product recovery management system reflects information accumulated during a recovery step of the recycler on designing of the product so that the recycler and a manufacturer interchange information with each other in order to maximize their profits.

While the present invention has been particularly shown and described with reference to exemplary embodiments thereof, it will be understood by those of ordinary skill in the art that various changes in form and details may be made therein without departing from the spirit and scope of the present invention as defined by the following claims.

The embodiments of the invention in which an exclusive property or privilege is claimed are defined as follows:

1. A product recovery management system that is connected to a product lifecycle information infrastructure and a Device to Ubiquitous (D2U) system in order to manage a product recovery process of a recycler, wherein the product lifecycle information infrastructure integrates and manages information accumulated throughout a product lifecycle and the D2U system integrates and manages products and peripheral devices equipment in a shop floor using ubiquitous technology, the product recovery management system comprising:
a D2U interface module for providing an interface with the D2U system;
a user interface module for providing an interface with a user terminal of a worker through the D2U system;
a product recovery management system (PRMS) database (DB) for storing product information and various types of information related to product recovery;
a product recognizing module configured to refer to one of the PRMS DB and the product lifecycle information infrastructure for obtaining information of a corresponding product using an identification (ID) of the product transmitted from the D2U interface module; and
a recovery plan making module for providing a user terminal of a worker with steps and related information necessary for a product recovery process through the user interface module using the product information collected from the product lifecycle information infrastructure.

2. The product recovery management system of claim 1, further comprising a knowledge-based module that establishes a product recovery plan through knowledge-based decision-making using a previous product recovery result according to a request of the recovery plan making module.

3. The product recovery management system of claim 2, wherein the knowledge-based module comprises:
a process editor that provides a user interface so as to edit the product recovery process;
a recovery result storage that stores information about the previous product recovery result; and
a case-based reasoning (CBR) engine that searches for a similar case of the previous product recovery result stored in the recovery result storage in order to perform knowledge-based reasoning.

4. The product recovery management system of claim 1, further comprising a virtual simulator module that shows a result of perform a graphic simulation with respect to a recovery process plan to a user terminal of the worker through the user interface module.

5. The product recovery management system of claim 1, further comprising a recovery result reporting module that generates the product recovery result as standardized data and provides the standardized data to an external system through the product lifecycle information infrastructure.

6. The product recovery management system of claim 1, wherein the product recognizing module refers to the PRMS DB for corresponding product information using a product ID transmitted from the D2U interface module, and if the PRMS DB does not store the corresponding product information, stores the reference result in the PRMS DB through the product lifecycle information infrastructure.

7. The product recovery management system of claim 1, wherein the recovery plan making module comprises:
a part inspecting module for supporting initial part inspecting;
a part disassembling module for supporting product disassembling;
a part recycling planning module for supporting a decision of a recycling plan of a material of each part; and
a remanufacturing planning module for supporting part recovery, product assembling, quality inspecting, and finishing steps.

8. The product recovery management system of claim 1, wherein the user interface module comprises a hardware communication device and a data model necessary for communications.

9. The product recovery management system of claim 1, wherein the PRMS DB includes:
product specification information about ID and specifications of each product;
product structure information about assembling structure of each product, part versions, combination relation definitions during assembling, and material specifications; and
product history information that is provided from each participant through a product lifecycle of a corresponding product.

10. The product recovery management system of claim 9, wherein the product structure information complies with standards of International Organization for Standardization (ISO) 10303-AP 203, ISO 14649, or ISO 10303-AP 224.

11. The product recovery management system of claim 9, wherein the product history information complies with standards of ISO 10303 AP 239.
